(19) United States
(12) Patent Application Publication
(10) Pub. No.: US 2003/0096604 A1
(43) Pub. Date: May 22, 2003

(54) Method of operating an electronic device, in particular a mobile telephone

(76) Inventor: Jorg Vollandt, Bochum (DE)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/940,640

(22) Filed: Aug. 29, 2001

(51) Int. Cl. H04M 3/00

(52) U.S. Cl. 455/419; 455/550; 455/566

(57) ABSTRACT

The present invention relates to a method of operating an electronic device, in particular a mobile telephone. To provide a special operating mode for triggering specific functions that can be used as a game the method comprising the steps of:

inputting a request for a specific function or a group of specific functions of the device, the request consists of at least a start sequence and a string of characters selected by a user,

comparing the characters of the string with characters of a randomly generated code string, and

performing the specific function or one of the group of specific functions if the string input by the user matches at least partly.

### BACKGROUND OF THE INVENTION

During operating an electronic device, like a computer, a mobile telephone or the like, a user inputs specific commands, instructions, requests and the like for starting a selected program, for causing a running program to perform specific jobs and/or functions, or the like via a keypad, a voice recognition system or any other suitable input means or by selecting a specific function from a menu. Usually the user of an electronic device knows the specific commands, instructions or requests associated with specific functions or can get the necessary information for triggering a desired function from a manual.

However, electronic devices, in particular mobile telephones are provided with special functions which are only necessary for testing the electronic devices. Consequently, for starting such special functions special codes are used which are normally not known to the common user but only to specialists.

One of such special functions used with mobile telephones is the so-called field test display that can be used to measure the receiving field strength provided by different telecommunications providers.

Further, some computer software includes programs hidden by the software designers, so-called “easter eggs”. Such hidden programs can be started by specific combinations of keys that are usually not needed by a user for operating the electronic device in a proper manner. For example, a simple flight simulator is hidden in spread sheet or tabulation program Excel 97 of Microsoft. This simple flight simulator can be started by a key combination not mentioned in the manual.

Such specific codes or key combinations not known from the manual but only published and spread around by rumor are interesting for many users, in particular for young users being very familiar with electronic devices. Such users are very eager to get such special codes by systematic trial and error activities. However, after the user got the special code completely the function or program activated with this code is usually not so interesting for a user as the trial and error activities necessary to get the code.

### SUMMARY OF THE INVENTION

The object of the present invention is to provide a further method of operating an electronic device, in particular a mobile telephone, that provides an operation mode for triggering specific functions that can be used as a game.

To achieve this object a method of operating an electronic device, in particular a mobile telephone, comprises the steps of: inputting a request for a specific function or a group of specific functions of the device, wherein the request consists of at least a string of characters selected by a user; comparing the characters of the string with characters of a randomly generated code string; and performing the specific function or one of the group of specific functions if the string input by the user matches at least partly.

Thus, according to the present invention a specific function or one of the group of specific functions will be performed only if one or more characters of an input string matches respective ones of a code string that is randomly generated at least for each individual electronic device, e.g. a mobile telephone. Therefore, each user who wants to know the code string has to try to get the code string by himself/herself and consequently it is only possible that one user informs the other about this particular operation mode but not about the code string for triggering specific functions.

E. g. such specific functions or actions of the device may be flashing of the contents of a display of the device, flashing of the backlight of the display, playing of a ringing tone or another short melody, presenting an animated graphic on the display, or the like.

Although it is possible to activate a special operation mode for triggering specific functions by selecting a corresponding menu item, it is prefered that the request comprises a start sequence leading the string of characters for activating this special operation mode.

To keep the user eager to get the code it is provided that the specific function or one of the specific functions is performed to indicate that one of the characters of the string input by the user matches a character of the code string. Hence, the user can get the code step by step so that she/he will not be discouraged or frustrated in case that he/she can not get the complete code in a reasonable time.

Another development of the present invention is characterized in that more than one of the group of specific functions are performed in case that more than one of the characters of the string input by the user match respective ones of the characters of the code string.

Further, according to specific refinement of the present invention it is provided that another specific function is performed in case that the string input by the user matches the code string.

Such another specific function or action may be a specific combination of the above mentioned actions or functions or may be e.g. making new ringing tones available, providing a special access code for downloading new ringing tones and/or new display logos via radio communications network or Internet, downloading new functions or actions for use with the operating mode provided by the present invention.

According to a preferred refinement of the present invention it is provided that the code string is changed by randomly generating a new code string after performing the specific function or functions if all of the characters of the string input by the user match the characters of the code string. Alternatively it is possible that the code string is changed by randomly generating a new code string at certain intervals; wherein the interval of changing the code string is randomly determined after each change of the code string.

Therefore, it is possible to keep the operation mode provided by the present invention interesting since the user has always to guess the valid code string for triggering certain actions or functions. Even if the user get the code prior to changing it, the user can be never sure whether the code he/she got is still the valid code.

According to a further development of the present invention the request is input by means of a keypad or by selecting characters from a list displayed on a display particularly by means of turn-push-button. Additionally it is possible that the request is input via an air interface. Thus, in case that the electronic device is a mobile telephone, a special string of characters can be sent via SMS (Short Message Service) to the mobile telephone of a friend as a request used in the operation mode provided by the present invention to see how her/his mobile telephone reacts on that request.

According to another preferred refinement of the present invention it is provided that the request comprises a terminating character indicating the end of the string of characters input by a user. Hence, it is not necessary to use a fix number of characters for both the input string and for the code string. In particular, the number of characters of the code string can be also changed randomly between certain values so that a user has also to enter input strings with different numbers of characters for getting the code.

### BRIEF DESCRIPTION OF THE DRAWINGS

The present invention will be explained in more detail with reference to the accompanying drawings showing preferred embodiments.

FIG. 1a shows a schematic block diagram of a mobile telephone operable in accordance with the present invention.

FIG. 1b shows a part of the block diagram of FIG. 1 for another embodiment of the present invention.

FIG. 2 shows a simplified schematic block diagram of the software architecture used with the present invention.

FIG. 3 shows a now chart of the method according to the present invention.

FIG. 4 shows a part of the flow chart according to FIG. 3 for another embodiment of the present Invention.

### DETAILED DESCRIPTION OF THE INVENTION

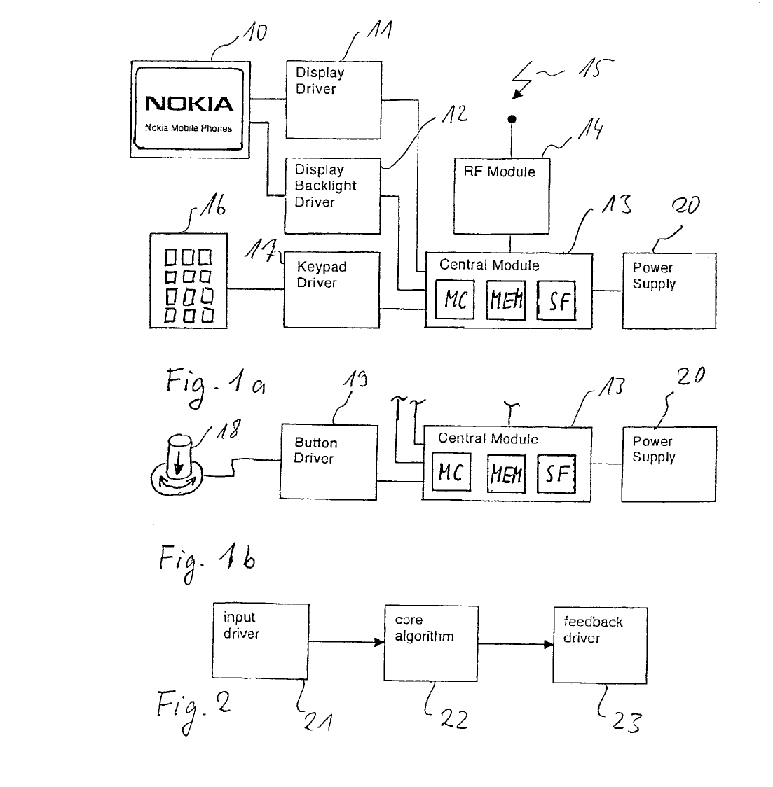

As shown in FIG. 1a, a usual mobile telephone operable with the present invention comprises a display 10 driven by a display driver 11 and provided with a backlight driven by a respective display backlight driver 12 and illuminating the background of the display so that the contents displayed thereon is shown with enhanced contrast. The display driver 111 and the display backlight driver 12 are connected to a central module 13 that comprises a microcontroller MC, a memory MEM and other support functions SF. The microcontroller MC of the central module is the master of the system. The central module 13 is connected to a radio frequency (RF) module 14 that is used for implementing an air interface 15 to enable access to a radio communications network. The RF module 14 is used for sending and receiving short messages (SMS) the contents thereof are generated or received by the microcontroller of the central module 13. In addition, the RF module 14 is used in a usual manner for sending and receiving data and/or information during a telephone call.

Further, a keypad 16 is connected to the central module 13 via a keypad driver 17 and serves as input means for operating the mobile telephone. As shown in FIG. 1b illustrating another embodiment of a mobile telephone used with the present invention, a turn-push-button 18 used as input means is connected to the central module 13 via a respective button driver 19. The turn-push-button 18 can be used instead of the keypad or in addition to the keypad 16. At least, a power supply module 20 is connected to the central module 13 to supply power for the whole system.

Whereas the keypad 16 and/or the turn-push-button 18 are used as input means the display is used as feedback device to display alphanumeric information as well as graphical items. The display 10 is controlled by the microcontroller MC of the central module 13 via the display driver 11. In addition, the backlight of the display 10 is used as feedback means as well. In particular, the backlight that is controlled by the microcontroller MC of the central module 13 via display backlight driver 12 illuminates the display to enhance the visibility of the contents shown on the display 10 and to indicate that the mobile telephone is active. In case that the input means, i.e. the keypad 16 and/or the turn-push-button 18 are locked to prevent unintended use of the mobile telephone the backlight is kept switched off by the microcontroller MC of the central module 13 so as to indicate that the input means have to be unlocked prior to operating the mobile telephone

As shown in FIG. 2 the software architecture comprises three different software modules, i.e. an input driver 21, a main program or core algorithm 22 and a feedback driver 23. The input driver 21 comprises the program routines necessary for receiving input information from the keypad 16, turn-push-button 18 or from the radio frequency module 14 according to the SMS standard, for extracting the special string from the request input by a user and for passing this special string to the core algorithm 22. Correspondingly, the feedback driver 23 comprises the program routines used to drive mobile telephone actions triggered by the core algorithm that will be explained in more detail below. According to the present embodiment the feedback driver 23 controls the display and the display backlight via display driver 11 and display backlight driver 12. In case that one of the functions or actions triggered by the core algorithm is playing a ringing tone or a melody the feedback driver 23 provides the necessary control information for a respective tone generator.

The core algorithm uses three variables for data storing and handling, i.e. the input string, the code string and an array of functions. The input string can be an array of a fixed number of characters, for example for four integers ranging from 0 to 9. Similarly, the code string is an array of a fixed number of characters and in accordance with the described embodiment an array of four integers ranging from 0 to 9.

To enhance the difficulty of getting the code string, it is also possible to vary the number of characters used for the code string randomly. In this case another variable is necessary to indicate the number of characters actually used for the code string.

At least, the action or function array is an array for a certain number of characters, e.g. of four integers ranging from 0 to 3 or of five integers ranging from 0 to 4. These integers refer to specific mobile telephone actions or functions, e.g. to flashing the contents of the display 10 several times, flashing the display backlight several times, playing a ringing tone or another short melody, or showing an animated graphic on the display 10. Another specific function or action that is referred to by one of the characters of the action array, e.g. by the last of the five integers may be a specific combination of the afore-mentioned actions or may be e.g. making new ringing tones available, providing a special access code for downloading new ringing tones, new melodies, and/or new display logos via the respective radio communications network or via Internet, or downloading new functions or actions for use with the present invention.

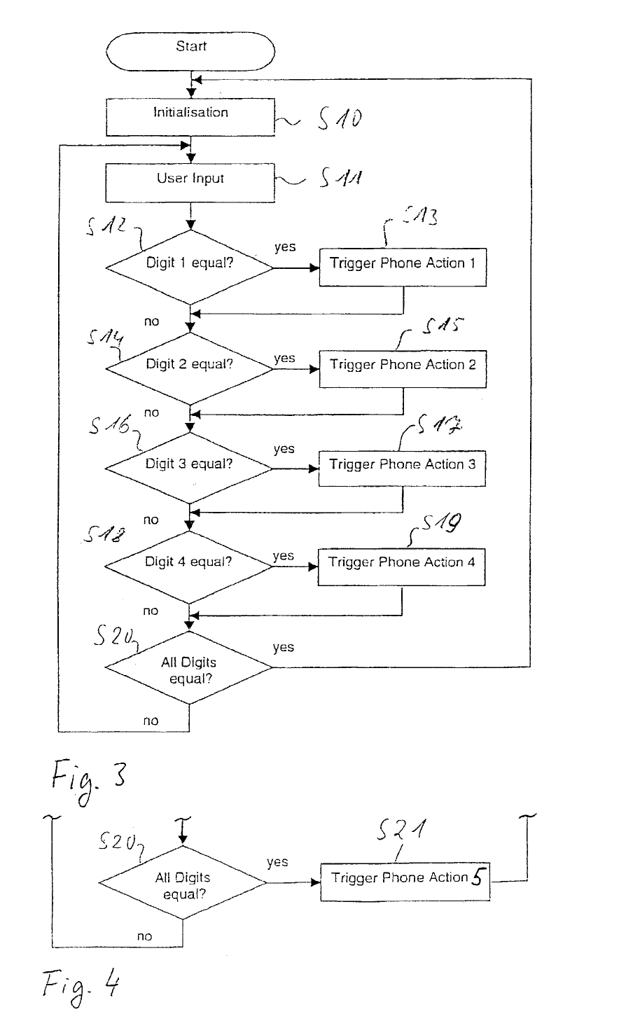

According to FIG. 3 the core algorithm for performing the inventive method performs an initialization step S10 after starting the algorithm. During initialization the array for the variable input string is cleared. Thereafter, the array for the variable code string is filled with four random integers. At least, the array for the action array is filled with four integers randomly as well.

However, it is also possible to use the code string used during the last runtime of the algorithm for the new runtime. In this case, it is checked whether or not the user got the complete code string during the last runtime and if not the code string remains unchanged. Otherwise the code string is changed by filling the respective array with four integers randomly.

According to another embodiment of the present invention, it is checked whether a certain predetermined time interval has been expired prior to changing the code string. In this case the code string will be only changed if the predetermined time interval has been expired. Thereafter, the length of the time Interval for determining changing of the code string can be also randomly determined.

After completing initialization a user inputs a request and the corresponding array is filled with four integers entered by the user as a request that preferably consists of a start sequence, e.g. “#”, the special input string of the four integers, e.g. “1234”, and a terminating character, e.g. “#”. Upon filling the integers or digits into the respective array in step S11, it is checked whether the first digit of the code string is equal to the first digit of the input string in step S12. If so, one of the above-mentioned specific actions is triggered in step S13. Thereafter, the algorithm continues with step S14 for checking whether or not the second digits of the code and the input string are equal. If so, a second specific function or phone action is triggered in step 15.

Thereafter, the third digits of the input and the code string are compared in step S16. If the compared digits are equal the next phone action is triggered in step S17.

Then, the fourth digits of the code and the input string are compared with each other and if they are equal to each other the fourth phone action is performed in step S19.

Then, it is checked in step S20 whether all digits of the input string equal the digits of the code string, i.e. whether the input string completely matches the code string. If not, the algorithm returns to step S11 so that the user has the chance to continue to guess the code string. Otherwise, i.e. in case that the input string completely matches the code string the method returns to the initialization in step S10 for changing at least the code string randomly.

According to another embodiment of the present invention it is also possible that in case that it was decided in step S20 that the input string completely equals the code string to trigger a special phone action in step S21 prior to repeating the initialization.

For triggering specific functions or phone actions in step S13, S15, S17, S19, and S21 trigger signals are generated only and supplied to the feedback driver 23. Thus, it is possible to perform the respective functions or phone actions in parallel or sequentially. Because the variable action array is set up randomly with integers during initialization, the specific functions or phone actions are independent from the digit number inside the input string and the code string.

Because the special string “*#1234#” does not interfere with any other user inputs there is no need to stop the algorithm so that the user can try to guess the actual code string every time after switching on his/her mobile telephone.

Since it is possible to replace the input via the keypad 16 or the turn-pushbutton 18 by an input via SMS, i.e. via the air interface 15, a user of another mobile telephone can participate in trying to get the code string.

Thus, to use the particular operation mode provided by the present invention it is only necessary to enter a specific string like “*#1234#” as a request for a specific function or a group of specific functions. The first two characters “*#” are used as start sequence, i.e. to activate, the particular operation mode. However it is also possible to activate the special operation mode provided by the present invention by selecting a corresponding menu item. The second “#” indicates the end of the string and is used as a terminating character. Such a terminating character can be omitted in case that the input string “1234” has a fixed number of digits. However, if the number of digits used for the code string can be varied randomly, a terminating character is necessary to indicate the end of the request. “1234” stands for a four-digit number input by a user.

Upon typing or inputting the request the number “1234” of the input string is compared with a random number, i.e. with the code string generated by the mobile telephone itself. In case that one or more digit of the input string matches a respective one of the code string, at least one specific function or phone action is triggered as described above.

Although the present invention has been explained in detail for use with a mobile telephone, it is also possible to use the present invention with another electronic device having input means, micro computer means, and feedback or output means, e.g. with a personal computer (PC).

1. A method of operating an electronic device, in particular a mobile telephone, comprising the steps of:
inputting a request for a specific function or a group of specific functions of the device, the request consists of at least a string of characters selected by a user,
comparing the characters of the string with characters of a randomly generated code string, and
performing the specific function or one of the group of specific functions if the string input by the user matches at least partly.

2. The method as claimed in claim 1, characterized in that the request comprises a start sequence leading the string of characters to activate a special operation mode for triggering specific functions.

3. The method as claimed in claim 1, characterized in that the specific function or one of the specific functions is performed to indicate that one of the characters of the string input by the user matches a character of the code string.

4. The method as claimed in claim 3, characterized in that more than one of the group of specific functions are performed in case that more than one of the characters of the string input by the user match respective ones of the characters of the code string.

5. The method as claimed in claim 3, characterized in that another specific function is performed in case that the string input by the user matches the code string.

6. The method as claimed in claim 1, characterized in that the code string is changed by randomly generating a new code string after performing the specific function or functions if all of the characters of the string input by the user match the characters of the code string.

7. The method as claimed in claim 1, characterized in that the code string is changed by randomly generating a new code string at certain intervals.

8. The method as claimed in claim 7, characterized in that the interval of changing the code string is randomly determined after each change of the code string.

9. The method as claimed in claim 1, characterized in that the request is input by means of a keypad.

10. The method as claimed in claim 1, characterized in that the request is input by selecting characters from a list displayed on a display particularly by means of turn-push-button.

11. The method as claimed in claim 1, characterized in that the request is input via an air interface.

12. The method as claimed in claim 1, characterized in that the request comprises a terminating character indicating the end of the string of characters input by a user.
